(19) United States
(12) Patent Application Publication
(10) Pub. No.: US 2003/0121238 A1
(43) Pub. Date: Jul. 3, 2003

(54) Dust collector venturi booster

(76) Inventor: Kenneth L. Richard, Uwchland, PA (US)

Correspondence Address: James G. O'Boyle, 711 Chevy Chase Building, 5530 Wisconsin Avenue, Chevy Chase, MD, 20815, US

(21) Appl. No.: 10/033,935

(22) Filed: Jan. 3, 2002

(51) Int. Cl. B01D 46/04

(52) U.S. Cl. 55/302

(57) ABSTRACT

A venturi booster mounted between axially aligned first and second filter elements in a dust collector of the type having a compressed air source for conveying pulses of compressed air to the filter elements for periodically reverse flow cleaning of the filter elements, the venturi booster being constructed and arranged to divide the compressed air flow to retain approximately 50% of the air flow within the first filter element and the balance passing through the venturi booster into the second filter element.

### BACKGROUND OF THE INVENTION

In dust collectors of the type shown in my U.S. Pat. No. 4,610,704 dated Sep. 9, 1986, a plurality of individual filter elements are enclosed in a housing which admits particulate laden gases into the top of the housing to flow downwardly and radially inwardly of the individual filter units so that particulates accumulate on the exterior of the filters. The interior of the filter elements communicate with a common clean air duct at the bottom of the housing. In order to periodically clean the filter elements, a compressed air source is arranged to fire pulses of air upwardly through the filter elements to remove the particulates from the exterior surface of the filter element. The location of a pulsed air source with a respective filter element is known as a filter cleaning station. When there was only one filter element per cleaning station, the pulses of compressed air cleaned the filter element efficiently; but in collectors where a second filter was installed in alignment with a first filter at a cleaning station, it was found that the pressure wave was greatly reduced by the time it reflected back from the second filter element, whereby the first filter element was not cleaned sufficiently.

This was noted particularly with cylindrical cartridge type filters having a pleated side wall extending the length of the cartridge and having annular channel caps at each end thereof. In these cartridge filters, the pulsed air jet rises within the filters upwardly through the center of the cartridges until it crashes against the far end clamping plate of the second filter to form a pressure wave which reflects back 180° expanding outwardly to force particulates back out of the second filter. This pressure wave expends itself in the second filter such that the pressure wave for cleaning the first filter is greatly reduced.

After considerable research and experimentation, the venturi booster of the present invention has been devised to divert about 50% within the first filter. As each of these two high velocity flows crash into the ends of each filter, each high pressure wave reflects back within a respective filter, which pressure waves expand outwardly thereby driving the deposited dust away from each filter.

### SUMMARY OF THE INVENTION

The venturi booster of the present invention is mounted between axially aligned first and second filter elements, and comprises, essentially, an outwardly flared conical sleeve portion extending into a hollow central core of the first filter element and spaced radially inwardly from the side wall thereof. The sleeve portion is provided with an integral radially outwardly extending base portion constructed and arranged for centering the sleeve portion within the first filter and for supporting the sleeve portion vertically within the first filter.

### BRIEF DESCRIPTION OF THE DRAWINGS

FIG. 1 is a side elevational view of a dust collector with a portion of the housing broken away to show a pair of cleaning stations, each having first and second aligned filter elements having the venturi booster of the present invention mounted therebetween.

FIG. 2 is a side elevational view of the booster of the present invention mounted between aligned first and second filter elements; and

FIG. 3 is a perspective view of the venturi booster of the present invention.

### DESCRIPTION OF THE PREFERRED EMBODIMENT

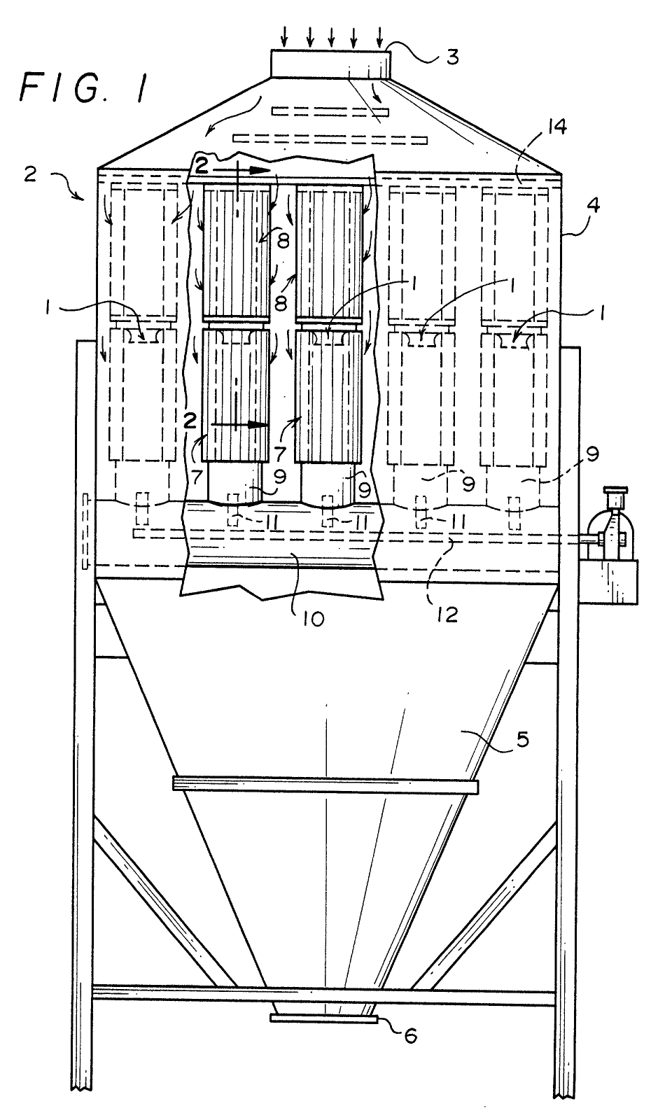

Referring to the drawings and more particularly to FIG. 1, the venturi booster 1 of the present invention is adapted to be installed in an industrial dust collector 2 of the type disclosed in my U.S. Pat. No. 4,610,704 dated Sep. 9, 1986, the disclosure of which is incorporated herein by reference. The dust collector 2 includes a housing having an inlet opening 3 at the top thereof for the admission of particulate-laden gases. An intermediate section 4 of the housing provides a dirty gas chamber, and the hopper or lower portion 5 of the housing tapers downwardly to a clean-out or dust discharge opening 6. The intermediate section 4 of the housing encloses a plurality of rows of individual axially aligned filter elements 7 and 8 having the venturi booster 1 of the present invention mounted therebetween. A plurality of filter stations 9 are positioned below the filter elements 7 and communicate between the lower open ends of the filter elements 7 and a clean air duct 10 through which the clean air is conducted to the atmosphere.

From the structure thus far described, it will be apparent that the particulate laden gases flowing downwardly through the inlet 3 surround the filter elements 7 and 8 and flow radially inwardly therethrough, leaving the lighter particulates entrained on the outer surface of each filter element 7 and 8. While heavier particles will continue on to the lower portion 5 of the housing 4, the thus cleaned gases exit from the center portions of the filter elements 7 and 8 into the filter station 9 and into the clean air duct 10 which conduct them to the atmosphere.

Reverse flow cleaning of the filter elements 7 and 8 is provided by a plurality of pulsed compressed air sources 11, one for each stack of filters 7 and 8. The pulsed compressed air sources 11 are positioned within the clean air duct 10 and communicate with the lower open end of a respective filter element 7. A compressed air line 12 extends through the clean air duct 10 and communicates with the pulsed compressed air sources and is provided with a plurality of compressed air outlet apertures aligned with the lower end of the venturis 11. A source of compressed air and suitable valves (not shown) are connected to the compressed air line 12 to permit the pulsed firing of jets of air into the filters 7 and 8 at each cleaning station so as to clean the filters. Since the general flow of air through the housing 4 is from top to bottom, the shock wave created by the pulsed firing of air jets into the filters aids in the movement of the particulates removed from the filters 7 and 8 during a cleaning cycle towards the clean-out opening 6.

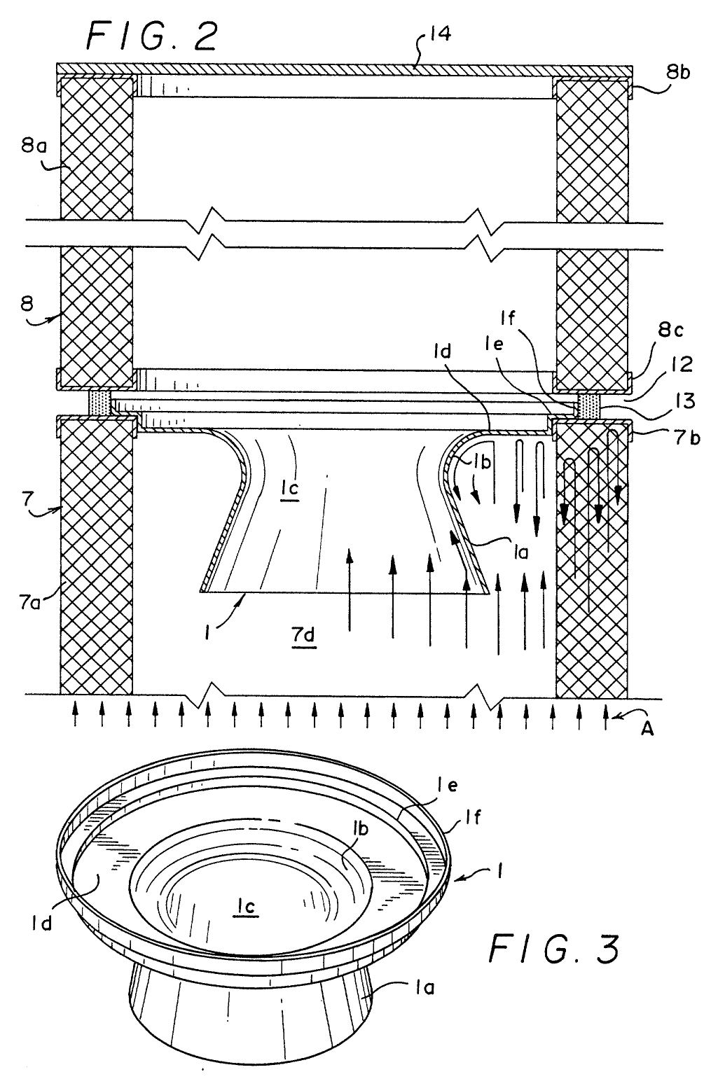

When there is only one filter element 7 per cleaning station, the pulses of compressed air cleans the filter element efficiently; but in collectors where a second filter element 8 is installed in alignment with the first filter 7 at a cleaning station, the pulsed jet air flow instantly reaches the far end of element 8 where its velocity is terminated producing a massive pressure wave. The return flow of this pressure wave cleans filter 8; however, the pressure wave quickly diminishes so as to clean filter 7 inadequately. This is experienced with cylindrical cartridge type filters 7, 8 as shown in FIG. 2 having a pleated side wall 7a, 8a extending the length of the cartridge and having annular channel caps 8b, 8c, 7b at each end thereof.

To enhance the cleaning of the first filter 7, the venturi booster 1 of the present invention is mounted between the upper end of filter cartridge 7 and the lower end of the filter cartridge 8 to allow about half of the rising pulsed air at the end of filter cartridge 7 to enter filter 8. As the supersonic velocity of this jet flow reaches the ends of filters 7 and 8, this flow is abruptly terminated resulting in a pressure wave which wave reverses its flow direction to force out dirt particles from filters 7 and 8 yielding uniform cleaning of both filters.

As shown in FIGS. 2 and 3, the venturi booster 1 of the present invention comprises an outwardly flared conical sleeve portion 1a extending into the center 7d of filter 7 and spaced radially inwardly from the side wall 7a thereof. The sleeve portion 1a is provided with an outwardly bent portion 1b which together with the outwardly flared portion 1a forms a throat portion 1c. The outwardly bent portion 1b is integral with a radially outwardly extending annular planar portion 1d which terminates at its periphery with an annular shoulder portion 1e having a peripheral lip 1f. The annular planar portion 1d and shoulder portion 1e provide a base for supporting and centering the sleeve portion 1a within filter 7. The shoulder portion 1e is supported on the filter end cap 7b and the lip 1f is positioned in a space 12 between the bottom end cap 8c having a gasket 13 affixed thereto. The lip 1f limits the downward movement of the filter 8 caused by heavy dust loading of the filter 8 which can result in overcompressing the gasket 13, resulting in the filters 7 and 8 moving closer to each other but opening a space between a clamp plate 14 and the cap 8b on the filter 8, thereby providing a gap between the dirty side and clean side of the filter.

While the venturi booster of the present invention has been described as being mounted between vertically arranged filter cartridges 7 and 8, it will be understood by those skilled in the art that the venturi booster 1 can also be mounted between horizontally arranged stacked cartridge filters, or any angle between 0 and 90°.

It is to be understood that the form of the invention herewith shown and described is to be taken as a preferred example of the same, and that various changes in the shape, size, and arrangement of parts may be resorted to, without departing from, the spirit of the invention or scope of the subjoined claims.

I claim:

1. In combination, a venturi booster and a dust collector of the type having at least one compressed air source for conveying pulses of compressed air to first and second tubular, axially aligned filter cartridges for periodically reverse flow cleaning the filter cartridges; said venturi booster being mounted between one end of said first filter cartridge and an adjacent end of said second filter cartridge; said venturi booster comprising an outwardly flared conical sleeve portion having a throat portion and an entrance portion extending into the center of said first filter and spaced radially inwardly from the side wall thereof, a radially outwardly extending annular planar portion integral with said conical sleeve and positioned between said first one end of said first filter and said adjacent end of said second filter cartridge, to thereby mount the conical sleeve between said one end of said first filter cartridge and an adjacent end of said second filter cartridge, whereby during the reverse flow cleaning of the first and second filter cartridges, the jet flow from the compressed air source flows upwardly through the center of the first filter cartridge and into the entrance of the outwardly flared conical sleeve portion and into the throat portion, to thereby divide the volume of the jet flow retaining approximately 50% of said flow within the first filter and the balance passing through the venturi booster to the second filter.

2. The combination of a venturi booster and a dust collector according to claim 1, wherein annular channel caps are mounted on each end of said first and second tubular filter cartridges, whereby the air flow of the first filter comes to an abrupt end when it hits the distal end cap of the first filter and the adjacent surfaces of the venturi booster such that a pressure wave thus formed reverses direction expanding outwardly to remove dust from the first filter, the initial air flow admitted to the second filter through the venturi booster coming to an abrupt end at the distal end of the second filter, creating a massive pressure wave which reverses direction to fill the second filter expanding outwardly to remove the dust entrained on the outer surface thereof.

3. The combination of a venturi booster and a dust collector according to claim 1, wherein an annular axially extending lip is integral with the periphery of the annular planar portion, said lip being positioned between said one end of said first filter and said adjacent end of said second filter, whereby the downward movement of said second filter toward said first filter is limited.

4. The combination of a venturi booster and a dust collector according to claim 1, wherein an annular shoulder is integral with the periphery of the annular planar portion for centering the venturi booster within the first filter.

5. In combination, a venturi booster and a dust collector of the type having at least one compressed air source for conveying pulses of compressed air to first and second tubular, axially aligned filter cartridges for periodically reverse flow cleaning the filter cartridges; said venturi booster being mounted between one end of said first filter cartridge and an adjacent end of said second filter cartridge; said venturi booster comprising a sleeve having an entrance portion extending into the center of the first filter and spaced radially inwardly from the side thereof, and a radially outwardly extending annular planar portion integral with said sleeve and positioned between said first one end of said first filter and said adjacent end of said second filter cartridge, whereby during the reverse flow cleaning of the first and second cartridges, the air flow from the compressed air source flows upwardly through the center of the first filter cartridge and into the entrance of the sleeve, whereby the volume of the air flow is divided to thereby retain approximately 50% of said flow within the first filter and the balance passing through the venturi booster into the second filter.
